(19) United States
(12) Patent Application Publication
(10) Pub. No.: US 2010/0303483 A1
(43) Pub. Date: Dec. 2, 2010

(54) IMAGE FORMING APPARATUS AND TONER REMAINING AMOUNT DETERMINING METHOD

(75) Inventor: Yoshihiro TAKAHASHI, Shizouka-ken (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/791,706

(22) Filed: Jun. 1, 2010

Related U.S. Application Data
(60) Provisional application No. 61/183,431, filed on Jun. 2, 2009.

(51) Int. Cl. G03G 15/08

(52) U.S. Cl. 399/27

(57) ABSTRACT

An image forming apparatus includes a development device in which a toner supplied by a toner cartridge section is carried by a magnetic carrier and is discharged, a first sensor to acquire information indicating a supply amount of the toner supplied by the toner cartridge section to the development device, a second sensor to acquire information indicating a toner density in the development device, and a controller which updates the information indicating the total supply amount and stored in a storage section storing information indicating a total supply amount of the toner supplied by the toner cartridge section to the development device based on the information acquired by the first sensor and determines a toner remaining amount in the development device based on the information indicating the total supply amount and stored in the storage section and the information indicating the toner density acquired by the second sensor.

### CROSS-REFERENCE TO RELATED APPLICATION

This application is based upon and claims the benefit of priority from: U.S. provisional application 61/183,431, filed on Jun. 2, 2009, the entire contents of each of which are incorporated herein by reference.

### FIELD

Described herein relates to an image forming apparatus.

### BACKGROUND

Hitherto, there is an image forming apparatus including a density detection section to detect a toner density in a developing device and a determination section to determine that there is no toner in the developing device when it is determined that the toner density detected by the density detection section is a toner density threshold value or less.

However, even when the toner density in the developing device is decreased to the density threshold value or less, there is a case where there is toner in a toner cartridge. When there is toner in the toner cartridge, it should not be determined that there is no toner.

### DESCRIPTION OF THE DRAWINGS

FIG. 1 is a longitudinal sectional view of an image forming apparatus.

FIG. 2 is a perspective view of a connector to and from which a toner cartridge is attached and detached, and the toner cartridge.

FIG. 3 is a block diagram of the image forming apparatus.

FIG. 4 is a flowchart showing a determination method of a toner remaining amount.

### DETAILED DESCRIPTION

In general, an embodiment relates to an image forming apparatus including a development device in which a toner supplied by a toner cartridge section is carried by a magnetic carrier and is discharged, a first sensor to acquire information indicating a supply amount of the toner supplied by the toner cartridge section to the development device, a second sensor to acquire information indicating a toner density in the development device, and a controller which updates the information indicating the total supply amount and stored in a storage section storing information indicating a total supply amount of the toner supplied by the toner cartridge section to the development device based on the information acquired by the first sensor and determines a toner remaining amount in the development device based on the information indicating the total supply amount and stored in the storage section and the information indicating the toner density acquired by the second sensor.

The embodiment further relates to a method of determining a toner remaining amount of a development device in an image forming apparatus including the development device in which a toner supplied by a toner cartridge section is carried by a magnetic carrier and is discharged, the toner remaining amount in the development device is determined based on information indicating a total supply amount of the toner supplied by the toner cartridge section to the development device and information indicating a toner density in the development device.

Hereinafter, embodiments will be described with reference to the drawings.

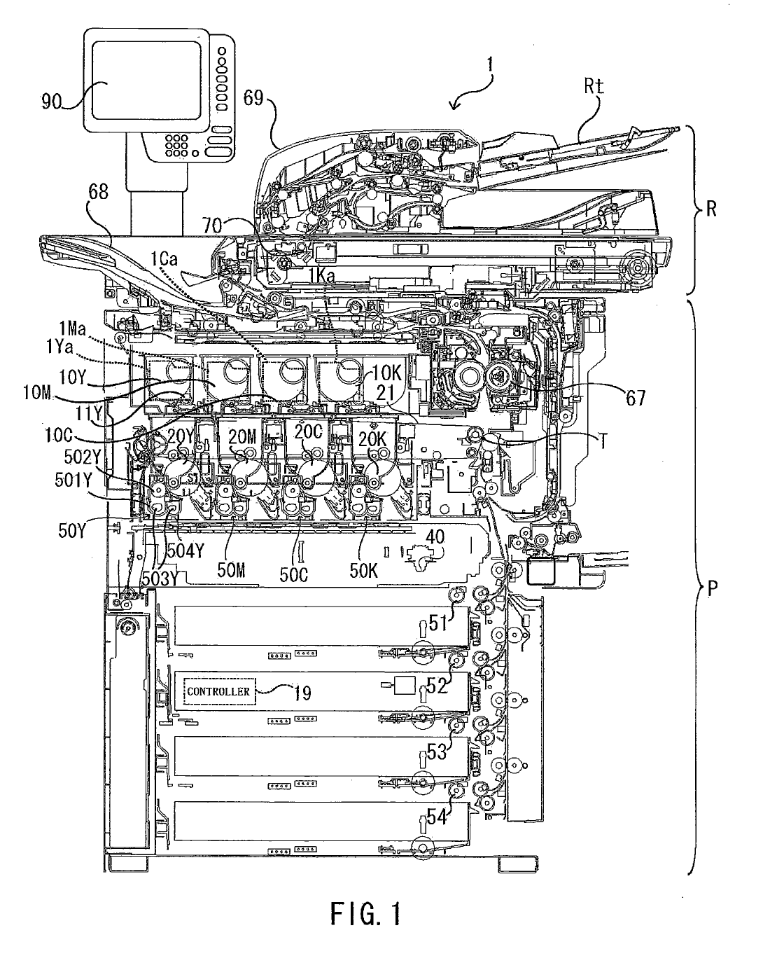

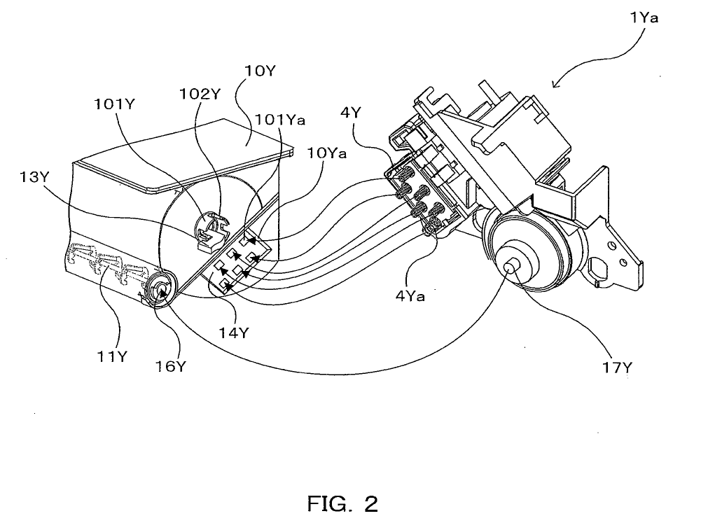

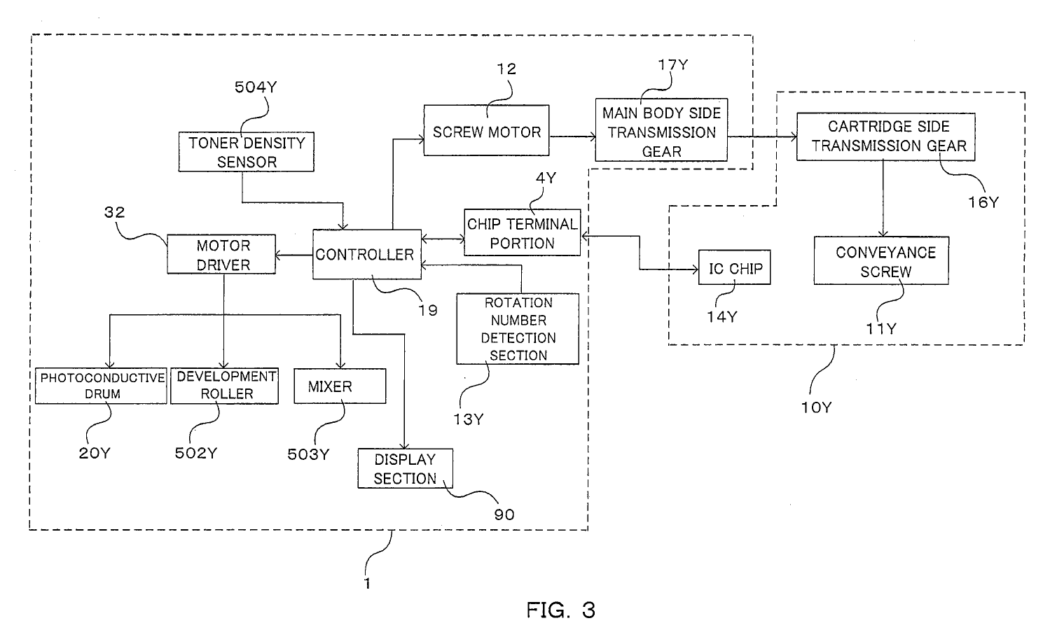

FIG. 1 is a longitudinal sectional view of an image forming apparatus. FIG. 2 is a perspective view of a connector to and from which a toner cartridge is attached and detached, and the toner cartridge, in which arrows indicate correspondence relations at the time of mounting. FIG. 3 is a block diagram of the image forming apparatus.

An image forming apparatus 1 includes an image reading section R and an image forming section P. The image reading section R scans and reads an image of a sheet document. The image forming section P forms a toner image on a sheet based on image data of the image read by the image reading section R. The image reading section R includes an auto document feeder 69 to automatically feed a document to a specified image reading position. A scanning optical system 70 reads the image of the document placed on a document tray Rt.

The image forming section P includes pickup rollers 51 to 54, toner cartridges 10Y to 10K, photoconductive drums 20Y to 20K, developing devices 50Y to 50K and a display section 90.

The pickup rollers 51 to 54 supply sheets picked up from cassettes to a sheet conveyance path. Based on the image data of the image read from the document by the image reading section R, a laser unit 40 forms electrostatic latent images on the respective photoconductive drums 20Y to 20K. The toner cartridges 10Y to 10K contain developers corresponding to yellow (Y), magenta (M), cyan (C) and black (K). The developing devices 50Y to 50K supply the respective developers to the respective photoconductive drums 20Y to 20K where the electrostatic latent images are positioned. Toner images positioned on the respective photoconductive drums 20Y to 20K are transferred onto the belt surface of an intermediate transfer belt 21. The toner images on the intermediate transfer belt 21 are transferred onto the conveyed sheet at a secondary transfer position T. The toner images transferred to the sheet are fixed by heating of a fixing unit 67. The sheet on which the toner images are fixed is discharged from a discharge tray 68.

The toner cartridge 10Y is mounted to the connector 1Ya of the image forming apparatus 1. In FIG. 1, the connector 1Ya is indicated by a dotted line. A conveyance screw 11Y cuts the toner contained in the toner cartridge 10Y and conveys it to a developing device 50Y. A screw motor 12 rotates the conveyance screw 11Y. The drive force of the screw motor 12 is transmitted to the conveyance screw 11Y through a main body side transmission gear 17Y and a cartridge side transmission gear 16Y. The toner cartridges 10M to 10K are respectively mounted to connectors 1Ma to 1Ka of the image forming apparatus 1. Incidentally, the connectors 1Ma to 1Ka are indicated by dotted lines in FIG. 1. The structures of the toner cartridges 10M to 10K are the same as that of the toner cartridge 10Y. Since the structures of the connectors 1Ma to 1Ka are the same as that of the connector 1Ya, their description is omitted. A controller 19 is electrically connected to the screw motor 12. The controller 19 controls the driving of the screw motor 12. The screw motor 12 may be a stepping motor or a DC brushless motor.

The toner cartridge 10Y includes a cylindrical portion 101Y at the center in the diameter direction. The cylindrical portion 101Y is positioned at one end of the toner cartridge 10Y in the longitudinal direction. The cylindrical portion 101Y includes notches 102Y provided at plural positions in the circumferential direction and at regular intervals. A rotation number detection section 13Y as a first sensor is positioned in the inside area of the cylindrical portion 101Y in the diameter direction and is fixed to the connector 1Ya. The rotation number detection section 13Y may be a photo interrupter. The rotation number detection section 13Y includes a light emitting element and a light receiving element, and detects the number of rotations of the screw motor 12 by detecting a light receiving state in which the light receiving element receives light emitted from the light emitting element and passing through the notch 102Y of the cylindrical portion 101Y, and a non-light receiving state in which light emitted from the light emitting element is blocked by a wall of the cylindrical portion 101Y and light reception of the light receiving element is inhibited. The controller 19 is electrically connected to the rotation number detection section 13Y and stores the number of rotations detected by the rotation number detection section 13Y into an IC chip 14Y as a storage section.

The toner cartridge 10Y includes a chip fixing portion 10Ya at one end face in the longitudinal direction. The IC chip 14Y is fixed to the chip fixing portion 10Ya and is integrated with the toner cartridge 10Y. The IC chip 14Y may be a RAM (Random Access Memory). The IC chip 14Y stores history information of toner. The history information may be the production date of the toner cartridge 10Y, lot No. and production site. The IC chip 14Y is attached to the chip fixing portion 10Ya at the time of production of the toner cartridge 10Y. The connector 1Ya includes a chip terminal portion 4Y. The chip terminal portion 4Y includes plural springs 4Ya. In the mounting state of the toner cartridge 10Y and the connector 1Ya, these springs 4Ya are respectively in press contact with terminal pads 101Ya of the chip fixing portion 10Ya. The IC chip 14Y is positioned in an area except the terminal pads 101Ya in the chip fixing portion 10Ya.

The IC chip 14Y stores the number of rotations (hereinafter referred to as the rotation number threshold value) of the screw motor 12 required for conveying all toner contained in the unused toner cartridge 10Y. Accordingly, when a phenomenon to prevent discharge of toner does not occur in the toner cartridge 10Y, when the screw motor 12 rotates by the rotation number threshold value, all the toner in the toner cartridge 10Y is moved to the developing device 50Y.

When the rotation of the screw motor 12 is stopped, the controller 19 updates the number of rotations stored in the IC chip 14Y. That is, the IC chip 14Y stores the total number of rotations of the screw motor 12 after the toner cartridge 10Y is mounted to the image forming apparatus 1. Accordingly, when the screw motor 12 does not rotate, the controller 19 does not update the total number of rotations stored in the IC chip 14Y. The controller 19 controls a motor driver 32. The photoconductive drum 20Y rotates in an arrow S direction based on the signal outputted by the motor driver 32.

The developing device 50Y is of a magnetic brush type, and includes a container 501Y, a development roller 502Y, a mixer 503Y and a toner density sensor 504Y as a second sensor. Since the developing devices 50M to 50K have the same structure as the developing device 50Y, their description is omitted. The mixer 503Y agitates a developer. The developer includes a toner for yellow and a carrier. The toner may include resin or carbon. The carrier includes ferrite and a coating layer formed on the surface of the ferrite. The coating layer is on the surface of the ferrite, so that friction charging between the carrier and the toner is stabilized.

When the mixer 503Y agitates the developer, a friction force is generated between the toner and the carrier, the carrier is charged to a plus, and the toner is charged to a minus. The development roller 502Y includes a magnet, and attracts the developer by the magnetic force to form a magnetic brush. When the magnetic brush contacts the photoconductive drum 20Y rotating in the arrow S direction, the electrostatic latent image of the photoconductive drum 20Y is developed.

The toner density sensor 504Y detects the toner density based on the magnetic permeability of the developer in the developing device 50Y. That is, when the carrier ratio of the developer in the developing device 50Y becomes high, the magnetic permeability becomes high, and the output value of the toner density sensor 504Y becomes high.

The toner density sensor 504Y is electrically connected to the controller 19. When the toner is moved from the developing device 50Y to the photoconductive drum 20Y, the toner density of the developer in the developing device 50Y is decreased. When the toner density of the developer is decreased, the quality of the developed image is degraded. Then, based on the output value outputted from the toner density sensor 504Y, when the toner density is decreased to a density threshold value or less as a second threshold value, the controller 19 drives the screw motor 12.

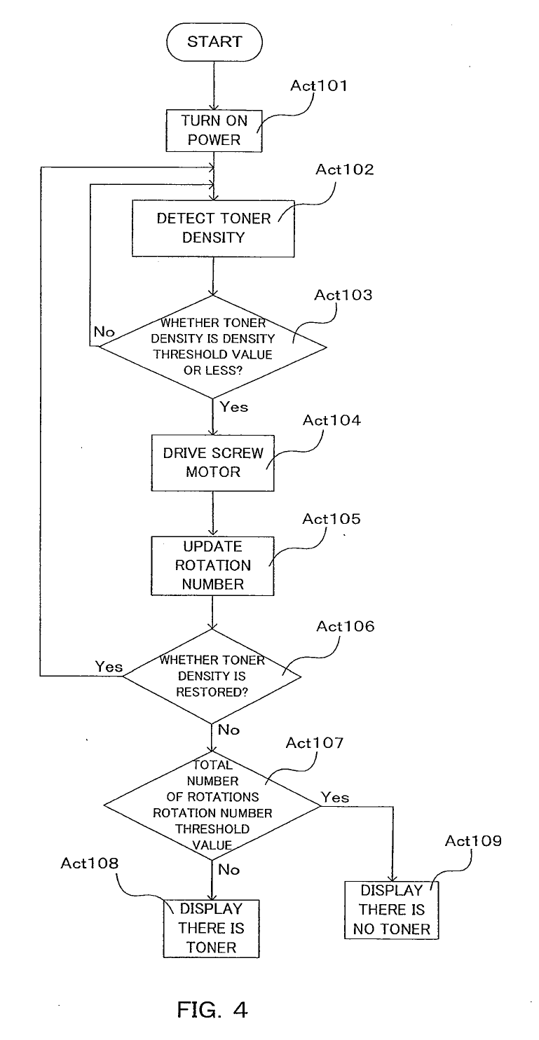

A method of determining the remaining amount of toner in the developing device 50Y will be described with reference to FIG. 4. FIG. 4 is a flowchart showing the determination method of the toner remaining amount. Incidentally, in the state before the toner cartridge 10Y is mounted to the connector 1Ya, the number of rotations of the screw motor 12 stored in the IC chip 14Y is 0. At Act 101, the power source of the image forming apparatus 1 is turned ON. At Act 102, the controller 19 outputs a signal to instruct density detection to the toner density sensor 504Y. At Act 103, the controller 19 determines whether the toner density is decreased to the density threshold value or less.

At Act 103, when the toner density is decreased to the density threshold value or less, advance is made to Act 104, and when the toner density is not decreased to the density threshold value or less, return is made to Act 102. At Act 104, the controller 19 performs drive control of the screw motor 12. The screw motor 12 rotates in accordance with the predetermined number of rotations. The predetermined number of rotations may be a designed value.

At Act 105, the controller 19 updates the total number of rotations of the screw motor 12 stored in the IC chip 14Y based on the detection result of the rotation number detection section 13Y.

At Act 106, based on the detection result of the toner density sensor 504Y, the controller 19 determines whether the toner density is restored. When the toner density is restored, return is made to Act 102, and when the toner density is not restored, advance is made to Act 107.

At Act 107, the controller 19 reads the total number of rotations of the screw motor 12 from the IC chip 14Y, and determines whether the total number of rotations is the rotation number threshold value or more. At Act 108, when the total number of rotations is less than the rotation number threshold value, the controller 19 displays, on the display section 90, information indicating that there is toner. At Act 109, when the total number of rotations is the rotation number threshold value or more, the controller 19 displays, on the display section 90, information indicating that there is no toner.

The information indicating that there is toner may be character information indicating a possibility that a phenomenon to prevent toner from moving to the developing device 50 from the toner cartridge 10Y occurs. The controller 19 may display solving means, together with this character information, on the display section 90. The solving means may be shaking of the toner cartridge 10Y.

At Act 107, when the total number of rotations is the rotation number threshold value or more, the controller 19 may store discrimination information indicating that toner disappears in the IC chip 14Y. Based on the discrimination information, the controller 19 may determine whether the toner cartridge 10Y is an original manufacturers product.

### Other Embodiments

Information indicating the supply amount of toner supplied to the developing device 50Y by the toner cartridge 10Y includes all parameters having correlation with the toner supply amount as exemplified below.

When the screw motor 12 is a pulse motor, the information indicating the supply amount of toner may be the number of rotations of the screw motor 12 calculated from the number of pulses of the pulse motor.

The information indicating the supply amount of toner may be the drive time of the screw motor 12 or the amount of toner discharged to the photoconductive drum 20Y by the developing device 50Y.

The detection section to acquire the drive time of the screw motor 12 may be the rotation number detection section 13Y. The controller 19 calculates the drive time of the screw motor 12 based on the number of rotations detected by the rotation number detection section 13Y and may store this drive time in the IC chip 14Y. When the screw motor 12 is a pulse motor, the controller 19 calculates the drive time from the number of pulses of the pulse motor, and may store this drive time in the IC chip 14Y.

The amount of toner discharged to the photoconductive drum 20Y by the developing device 50Y may be calculated from the number of pixels irradiated by the laser unit 40, or may be calculated from the light emission time of the laser unit 40.

The rotation number threshold value may be less than the total number of rotations of the screw motor 12 required for conveying all toner in the unused toner cartridge 10Y. That is, the controller 19 may determine that the state where toner slightly remains in the toner cartridge 10Y is the state where there is no toner in the developing device 50Y.

The controller 19 may be in the IC chip 14Y. The IC chip 14Y executes the flowchart of FIG. 4.

The present invention can be carried out in various forms without departing from the spirit thereof or the principle features. Thus, the foregoing embodiments are merely examples in all points and should not be interpreted restrictedly. The scope of the present invention is defined by the claims and is not restricted by the text of the specification. Further, all modifications, various improvements, substitutions and alterations within the scope equivalent to the claims are within the scope of the invention.

What is claimed is:

1. An image forming apparatus comprising:
a connector configured to connect with a toner cartridge containing a toner, the toner cartridge including a memory configured to store first information indicating a first amount of the toner;
a development device configured to discharge the toner by a magnetic carrier;
a first sensor configured to acquire second information indicating a second amount of the toner supplied from the toner cartridge to the development device;
a second sensor configured to acquire third information indicating a toner density in the development device; and
a controller configured to update the first information based on the second information and configured to determine a third amount of the toner contained in the development device based on the first information and the third information.

2. The apparatus of claim 1, wherein the controller determines that there is toner in the development device when the first information is less than a first threshold value and the third information is a second threshold value or less.

3. The apparatus of claim 2, wherein the controller determines that the development device is in a state of toner empty when the first information is the first threshold value or more and the third information is the second threshold value or less.

4. The apparatus of claim 3, wherein after the controller determines that the third information is the second threshold value or less, the controller compares the first information with the first threshold value and determines the third amount of the toner.

5. The apparatus of claim 1, further comprising
a conveyance screw to convey the toner from the toner cartridge section to the development device, and
a motor to drive the conveyance screw,
wherein the first sensor acquires the number of rotations of the motor.

6. The apparatus of claim 1, further comprising
a conveyance screw to convey the toner from the toner cartridge section to the development device, and
a motor to drive the conveyance screw,
wherein the first sensor acquires a drive time of the motor.

7. The apparatus of claim 1, further comprising
a photoconductive drum in which the toner discharged from the development device is attached to an electrostatic latent image formed on a surface,
wherein the first sensor acquires information indicating an amount of the toner discharged from the development device to the photoconductive drum.

8. The apparatus of claim 2, wherein the first threshold value corresponds to a total amount of the toner contained in the toner cartridge section before use.

9. The apparatus of claim 1, wherein the toner cartridge section includes the storage section.

10. The apparatus of claim 1, wherein the storage section is a RAM (Random Access Memory).

11. The apparatus of claim 1, further comprising a display section to display a determination result of the controller.

12. The apparatus of claim 1, wherein the second sensor acquires a magnetic permeability in the development device.

13. A method of determining a third amount of the toner contained in a development device in an image forming apparatus including the development device configured to discharge the toner by a magnetic carrier and a connector configured to connect with a toner cartridge containing a toner, the toner cartridge including a memory configured to store first information indicating a first amount of the toner, the method comprising
determining the third amount of the toner contained based on the first information and third information indicating a toner density in the development device.

14. The method of claim 13, wherein when the first information is less than a first threshold value and the third information is a second threshold value or less, it is determined that there is toner in the development device.

15. The method of claim 14, wherein when the first information is the first threshold value or more and the third information is the second threshold value or less, it is determined that the development device is in a state of toner empty.

16. The method of claim 15, wherein after it is determined that the third information is the second threshold value or less, the first information is compared with the first threshold value and the third amount of the toner is determined.

17. The method of claim 13, wherein the information indicating the first information is a total number of rotations of a motor to drive a conveyance screw to convey the toner from the toner cartridge section to the development device.

18. The method of claim 13, wherein the information indicating the first information is a total drive time of a motor to drive a conveyance screw to convey the toner from the toner cartridge section to the development device.

19. The method of claim 13, wherein the information indicating the first information is a total amount of the toner discharged from the development device to a photoconductive drum.

20. The method of claim 14, wherein the first threshold value corresponds to a total amount of the toner contained in the toner cartridge section before use.
